(19) United States
(12) Patent Application Publication
(10) Pub. No.: US 2025/0381744 A1
(43) Pub. Date: Dec. 18, 2025

(54) EYEWEAR AND A METHOD FOR FORMING THE EYEWEAR

(71) Applicant: Honeywell Safety Products USA, Inc., Charlotte, NC (US)

(72) Inventor: Domingo LLANOS MOLINA, Mexico City (MX)

(21) Appl. No.: 18/747,017

(22) Filed: Jun. 18, 2024

(51) Int. Cl. B29D 11/00; B29D 12/02; G02C 5/22

(52) U.S. Cl. CPC B29D 11/00009; B29D 12/02; G02C 5/22

(57) ABSTRACT

An eyewear is disclosed. The eyewear comprising a front portion, a temple portion, and a hinge portion provided between and connecting with the front portion and the temple portion. Further, the front portion and the temple portion comprise an optical polymer material and the hinge portion comprises an elastomer.

### TECHNOLOGICAL FIELD

Example embodiments of the present disclosure relate generally to protective eyewear, and more particularly, to eyewear and a method for forming the eyewear.

### BACKGROUND

In various industrial applications, eyewear is an important component of personal protective equipment (PPE). The eyewear is provided to workers in various industrial areas such as production facilities, utilities, and industrial settings, as a safety eyewear. The safety eyewear is employed to protect the worker's eyes while performing one or more operations that may require protection to the worker's eyes. Safety eyewear is an indispensable tool for safeguarding eyes in the workplace, which may require highly durable material to make the eyewear. Further, repeated wear and tear and unwanted drops of the eyewear may cause damage to the eyewear, and thereby increases the need for advanced, high quality eyewear.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, an eyewear is disclosed. The eyewear comprising a front portion, a temple portion, and a hinge portion provided between and connecting with the front portion and the temple portion. Further, the front portion and the temple portion comprise an optical polymer material and the hinge portion comprises an elastomer.

In some embodiments, the eyewear corresponds to a frameless single lens structure. Further, the frameless single lens structure is coated with an anti-fog material. In some embodiments, the optical polymer material is formulated by adding pigments, colours, or additives to provide optical radiation protection. In some embodiments, the optical polymer material comprises at least one of a polycarbonate material, polystyrene material, or polymethyl methacrylate material.

In some embodiments, the eyewear is formed by a two shot moulding process comprising a first shot injection and a second shot injection. Further, the optical polymer material is injected during the two shot moulding process at a predefined temperature. Further, the predefined temperature ranges between 250-270 degree Celsius.

In some embodiments, the eyewear is formed by the two shot moulding process comprising the first shot injection and the second shot injection. The optical polymer material is moulded during the two shot moulding process at a mold predefined temperature, wherein the mold predefined temperature ranges between 50-70 degree Celsius.

In some embodiments, the elastomer comprises at least one of a thermoplastic elastomer (TPE), thermoplastic vulcanizate (TPV), thermoset elastomer, thermoplastic polyurethane (TPU) or thermoset liquid silicone rubber (LSR).

In some embodiments, the eyewear is formed by the two shot moulding process comprising the first shot injection and the second shot injection. Further, the thermoplastic elastomer is moulded during the two shot moulding process at a predefined temperature. Further, the predefined temperature ranges between 220-260 degree Celsius. The thermoplastic elastomer is moulded during the two shot moulding process at a mold predefined temperature, wherein the mold predefined temperature ranges between 20-50 degree Celsius.

In some embodiments, the eyewear is formed by a two shot moulding process comprising the first shot injection and the second shot injection. Further, the thermoset elastomer is moulded during the two shot moulding process at a predefined temperature of 10-40 degree Celsius. The thermoset elastomer is moulded during the two shot moulding process at a mold predefined temperature, wherein the mold predefined temperature ranges between 150-300 degree Celsius.

In some embodiments, the front portion corresponds to a lens portion that is positioned in front of an eye of a user and the temple portion is configured to fold and unfold due to a flexibility of the hinge portion. In some embodiments, the hinge portion comprises a first ribbed surface and a second ribbed surface, the second ribbed surface being opposite to the first ribbed surface.

In another example embodiment, a method is disclosed. The method comprises steps of injecting, via a first shot injection, an optical polymer material into a mould to form a front portion of the eyewear, a temple portion of the eyewear, or both. Further, the method comprises injecting, via a second shot injection, an elastomer into the mould to form a hinge portion of the eyewear that connects with the front portion of the eyewear, the temple portion of the eyewear, or both.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1A illustrates a front isometric view of an eyewear in accordance with an example embodiment of the present disclosure;

FIG. 1B illustrates a rear isometric view of the eyewear in accordance with an example embodiment of the present disclosure;

FIG. 2 illustrates an exploded view of a portion of the eyewear in accordance with an example embodiment of the present disclosure;

FIG. 3A illustrates a schematic top view of the eyewear showing a folded state of the temple portion in accordance with an example embodiment of the present disclosure;

FIG. 3B illustrates a schematic top view of the eyewear showing an unfolded state of the temple portion in accordance with an example embodiment of the present disclosure; and

FIG. 4 illustrates a flowchart showing a method for forming the eyewear in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of an eyewear is disclosed. Embodiments may comprise a front portion, a temple portion, and a hinge portion that may be provided between and connected with the front portion and the temple portion. Further, the front portion and the temple portion may comprise an optical polymer material and the hinge portion may comprise an elastomer.

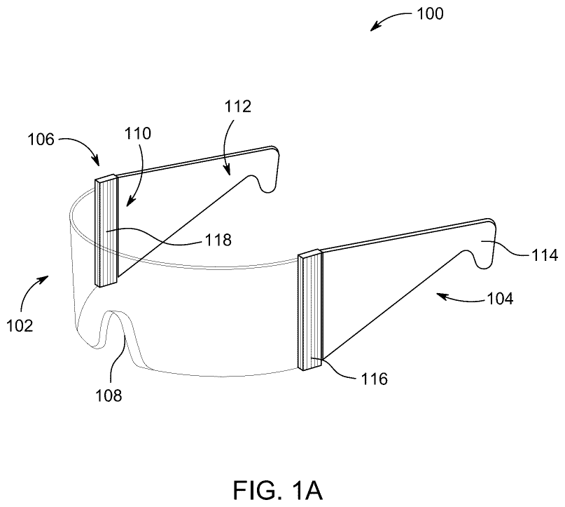

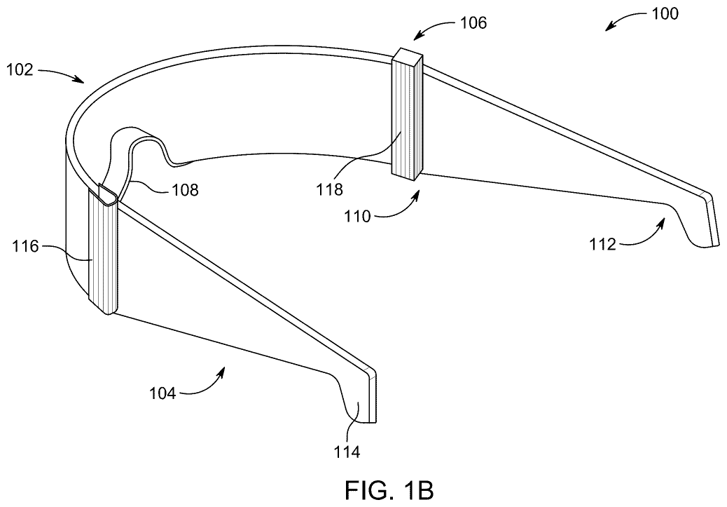

FIG. 1A illustrates a front isometric view of an eyewear 100, in accordance with an example embodiment of the present disclosure. FIG. 1B illustrates a rear isometric view of the eyewear 100, in accordance with an example embodiment of the present disclosure.

In some embodiments, the eyewear 100 may comprise a front portion 102, a temple portion 104, and a hinge portion 106. In some embodiments, the eyewear 100 may be configured to be worn by a user over an eye portion of the user. Further, the eyewear 100 may be configured to protect the eye portion of the user from a plurality of hazards. Further, the plurality of hazards may comprise at least one of a radiation, chemical splashes, emission of heat, sharp object, etc. In some embodiments, the eyewear 100 may be constructed such that one or more properties of the eyewear 100 may be ensured. In some embodiments, the one or more properties may comprise lightweight, durable, compact, etc.

In some embodiments, the eyewear 100 may correspond to a frameless single lens structure. Further, the frameless single lens structure may be configured to properly cover the eye portion of the user. In one example, a frameless feature of the eyewear 100 may ensure the lightweight properties of the eyewear 100. Further, the eyewear 100 may have one or more dimensions. Further, the one or more dimensions may define as per 8 or 9 base curvature. In some embodiments, the one or more dimensions may be selected such that the eye portion of the user may get properly covered by the eyewear 100. In some embodiments, the eyewear 100 may be crafted with a shape that may include but not limited to a round, an oval, a cat-eye, a rectangular shape, etc. In some embodiments, the shape of the eyewear 100 may be selected such that the eyewear 100 perfectly fits on the eye portion of the user.

In some embodiments, the eyewear 100 may correspond to the frameless single lens structure. Further, the frameless single lens structure of the eyewear 100 may be coated with an anti-fog material. In some embodiments, the anti-fog material coated on the eyewear 100 may be composed of one or more sub-materials. Further, the one or more sub-materials may be selected from a group of materials such as, but not limited to polysiloxane or silicone based material and alike. In some embodiments, the anti-fog material of the eyewear 100 may prevent accumulation of fog on the eyewear 100. In one example, when the eyewear 100 may be exposed to a humid environment, the anti-fog material of the eyewear 100 may prevent accumulation of the fog on the eyewear 100.

As illustrated in FIGS. 1A-1B, the eyewear 100 may further comprise a nose bridge 108. Further, the nose bridge 108 of the eyewear 100 may be configured to provide support to the eyewear 100 on the user's nose. Further, the nose bridge 108 may be configured to prevent slipping of the eyewear 100 from the user's nose. In one example, the nose bridge 108 may have surface roughness that provides grip to the eyewear 100 when placed on the user's nose. In some embodiments, the nose bridge 108 of the eyewear 100 may be configured to provide the support to the eyewear 100 on the user's nose. In some embodiments, the nose bridge 108 may be constructed with a shape that may include but not limited to an inverted U-shape, an inverted V-shape, etc.

In some embodiments, the eyewear 100 may comprise the front portion 102. In some embodiments, the front portion 102 of the eyewear 100 may be configured to be positioned in front of the eye portion of the user, when the eyewear 100 is rested on the user's nose. In some embodiments, the front portion 102 of the eyewear 100 may be configured to cover the eye portion of the user. In some embodiments, the front portion 102 of the eyewear 100 may correspond to a lens portion. In some embodiments, the front portion 102 of the eyewear 100 may define a radius of curvature similar to the radius of curvature defined by the eyewear 100. In some embodiments, the lens portion of the eyewear 100 may be composed of a material that may be transparent or translucent in nature.

In some embodiments, the eyewear 100 may further comprise the temple portion 104. Further, the temple portion 104 of the eyewear 100 may be configured to provide support to the eyewear 100 on the user's ears. Further, the temple portion 104 may be configured to rest over the user's ears. In some embodiments, the temple portion 104 may define a length of 130-150 mm. Further, the temple portion 104 may be configured to cover a temple region of the user's face. In some embodiments, the temple portion 104 may further comprise a first end 110 and a second end 112. Further, the second end 112 of the temple portion 104 may further comprise an L-shaped protrusion 114. Further, the L-shaped protrusion 114 at the second end 112 of the temple portion 104 may be configured to restrict movement of the eyewear 100 during movement of the user when the temple portion is positioned over the user's ears. For example, each second end 112 may be configured to be positioned overs and/or behind a user's ear to restrict movement of the eyewear 100. In some embodiments, the first end 110 of the temple portion 104 may be coupled with the front portion 102 of the eyewear 100 through the hinge portion 106.

In some embodiments, the front portion 102 of the eyewear 100 and the temple portion 104 of the eyewear 100 may be composed of a material that may correspond to an optical polymer material. Further, the optical polymer material may cause the front portion 102 and the temple portion 104 to provide protection from optical radiations. In some embodiments, the optical polymer material of the front potion and the temple portion 104 of the eyewear 100 may be formulated by adding pigments, colours, or additives to provide optical radiation protection. Further, the optical polymer material of the front portion 102 and the temple portion 104 of the eyewear 100 may be composed of one or more sub-materials. Further, the sub-materials may be selected from a group of materials such as, but not limited to, polycarbonate material, polystyrene material, or polymethyl methacrylate material, etc.

In some embodiments, the eyewear 100 may comprise the hinge portion 106. In some embodiments, the eyewear 100 comprises two hinge portions 106 and each hinge portion 106 may be provided between the front portion 102 of the eyewear 100 and the first end 110 of the temple portion 104. In some embodiments, the hinge portion 106 of the eyewear 100 may be configured to connect with the front portion 102 and the temple portion 104 of the eyewear 100. In some embodiments, the hinge portion 106 of the eyewear 100 may be configured to define an axis. In some embodiments, the hinge portion 106 may be configured to bend on the axis once a sufficient amount an external force is applied by the user on the temple portion 104 of the eyewear 100. Further, upon application of the sufficient amount of the external force on the temple region, the hinge portion 106 may allow the temple portion 104 to fold or unfold.

In some embodiments, the hinge portion 106 of the eyewear 100 may be composed of a material that may correspond to an elastomer. In some embodiments, the material of the hinge portion 106 may be selected to enable bending of the hinge portion 106 over the axis. In some embodiments, the elastomer may be composed of one or more sub-materials. Further, the sub-materials may comprise at least one of a thermoplastic elastomer (TPE), thermoset elastomer, thermoplastic vulcanizate (TPV), thermoplastic polyurethane (TPU), or thermoset liquid silicone rubber (LSR).

In some embodiments, the hinge portion 106 may comprise a first ribbed surface 116 and a second ribbed surface 118. In some embodiments, the first ribbed surface 116 and the second ribbed surface 118 may be configured to provide flexibility to the hinge portion 106. Further, the first ribbed surface 116 and the second ribbed surface 118 may enable bending of the hinge portion 106 on the axis. Further, the first ribbed surface 116 may be positioned opposite to the second ribbed surface 118 of the hinge portion 106. In some embodiments, the first ribbed surface 116 of the hinge portion 106 and the second ribbed surface 118 of the hinge portion 106 may be configured to define a stepped structure.

In some embodiments, the eyewear 100 may be formed by a two shot moulding process. Further, the two shot moulding process may be configured to produce the front portion 102 and/or the temple portion 104, and the hinge portion 106 of the eyewear 100. In some embodiments, the two shot moulding process involves a setup having a mould (not shown), and at least two injection units (not shown). In some embodiments, the mould may further comprise a first section and a second section. Further, the first section of the mould may be dedicated to cast the front portion 102 and/or the temple portion 104 of the eyewear 100. Further, the second section of the mould may be dedicated to cast the hinge portion 106 of the eyewear 100. In some embodiments, one injection unit of the at least two injection units may be configured to be connected with the first section of the mould. Further, another injection unit of the at least two injection units may be configured to be connected with the second section of the mould.

Further, one injection unit of the at least two injection units may be configured to contain the optical polymer material. Further, another injection unit may be configured to contain the elastomer. In one example, each of the injection unit may be configured to contain the optical polymer material and the elastomer in a molten state. In some embodiments, the two shot moulding process may involve a sequential injection of the optical polymer material and the elastomer into the first section of the mould and the second section of the mould. In some embodiments, the two shot moulding process may comprises a first shot injection and a second shot injection. In some embodiments, the first shot injection and the second shot injection may be performed sequentially in order to cast the eyewear 100. In one example, the two shot moulding process may be controlled and monitored by an external controller that may be communicatively coupled with the setup.

In some embodiments, during the two shot moulding process, the optical polymer material may be injected into the mould at a predefined temperature. In some embodiments, the predefined temperature may range between 250-270 degree Celsius. Successively, the optical polymer material may be moulded during the two shot moulding process at a mold predefined temperature. Further, the mold predefined temperature may range between 50-70 degree Celsius. Further, the two step moulding process may comprise a cooling time period after moulding of the optical polymer material. In some embodiments, after commencement of the cooling time period the optical polymer material may get casted into the front portion 102 and the temple portion 104 of the eyewear 100.

In some embodiments, during the two shot moulding process, the thermoplastic elastomer may be injected into the mould at a predefined temperature. In some embodiments, the predefined temperature may range between 220-260 degree Celsius. Successively, the thermoplastic elastomer may be moulded during the two shot moulding process at a mold predefined temperature. Further, the mold predefined temperature may range between 20-50 degree Celsius. Further, the two step moulding process may comprise another cooling time period after moulding of the elastomer. In some embodiments, after commencement of the another cooling time period the elastomer may get casted into the hinge portion 106 of the eyewear 100.

In some embodiments, during the two shot moulding process, the thermoset elastomer may be injected into the mould at a predefined temperature. In some embodiments, the predefined temperature may range between 10-40 degree Celsius. Successively, the thermoset elastomer may be moulded during the two shot moulding process at a mold predefined temperature. Further, the mold predefined temperature may range between 150-300 degree Celsius. Further, the two step moulding process may comprise another curing time period after moulding of the elastomer. In some embodiments, after commencement of the another curing time period the elastomer may get casted into the hinge portion 106 of the eyewear 100.

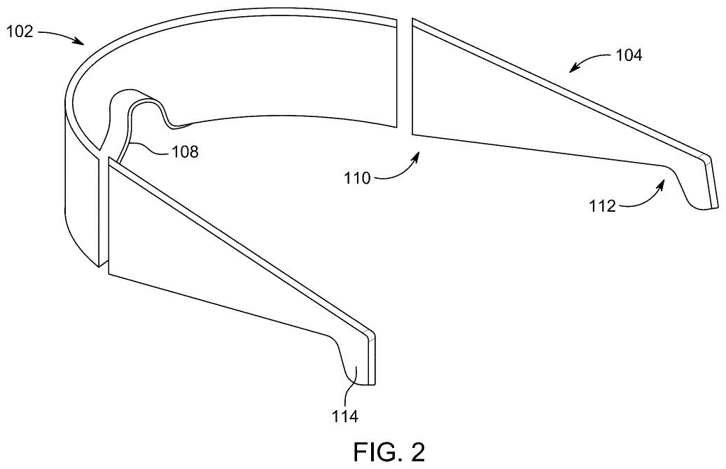

FIG. 2 illustrates an exploded view of a portion of the eyewear 100, in accordance with an example embodiment of the present disclosure. FIG. 2 is described in conjunction with FIGS. 1A-1B.

In some embodiments, the two step moulding process may comprise the first shot injection and the second shot injection. In one example, the first shot injection may involve injection of the optical polymer material into the mould to cast the front portion 102 and the temple portion 104 of the eyewear 100. Firstly, one of the at least two injection units may be configured to inject the optical polymer material into the mould, during the first shot injection. Further, the optical polymer may be maintained at the predefined temperature (i.e., 250-270 degree Celsius) within one of the injection unit. Secondly, upon injecting the optical polymer material into the mould, the optical polymer material may be moulded at the predefined temperature (i.e., 50-70 degree Celsius). Further, the two step moulding process may comprise a cooling time period after moulding of the optical polymer material. In some embodiments, after commencement of the cooling time period the optical polymer material may get casted into the front portion 102 and the temple portion 104 of the eyewear 100. FIG. 2 illustrates the eyewear 100 after the first shot injection but before the second shot injection.

In another example, the second shot injection may involve injection of the thermoplastic elastomer into the mould to cast the hinge portion 106 of the eyewear 100. Firstly, another injection unit of the at least two injection units may be configured to inject the thermoplastic elastomer into the mould, during the second shot injection. Further, the thermoplastic elastomer may be maintained at the predefined temperature (i.e., 220-260 degree Celsius) within the another injection unit. Secondly, upon injecting the thermoplastic elastomer into the mould, the thermoplastic elastomer may be moulded at the predefined temperature (i.e., 20-50 degree Celsius). Further, the two step moulding process may comprise a cooling time period after moulding of the thermoplastic elastomer. In some embodiments, after commencement of the cooling time period the thermoplastic elastomer material may get casted into the hinge portion 106 of the eyewear 100.

In another example, the second shot injection may involve injection of the thermoset elastomer into the mould to cast the hinge portion 106 of the eyewear 100. Firstly, another injection unit of the at least two injection units may be configured to inject the thermoset elastomer into the mould, during the second shot injection. Further, the thermoset elastomer may be maintained at the predefined temperature (i.e., 10-40 degree Celsius) within the another injection unit. Secondly, upon injecting the thermoset elastomer into the mould, the thermoset elastomer may be moulded at the predefined temperature (i.e., 150-300 degree Celsius). Further, the two step moulding process may comprise a curing time period after moulding of the thermoset elastomer. In some embodiments, after commencement of the curing time period the thermoset elastomer material may get casted into the hinge portion 106 of the eyewear 100.

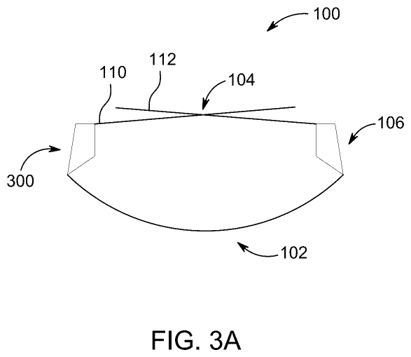

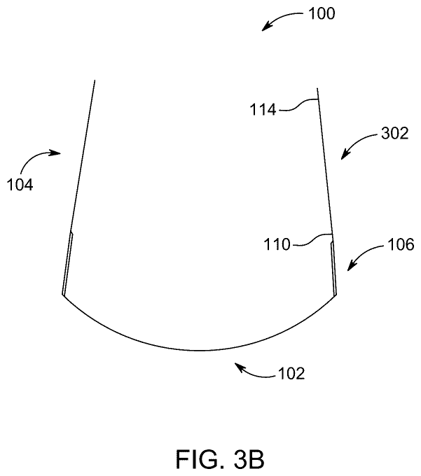

FIG. 3A illustrates a schematic top view of the eyewear 100 showing a folded state 300 of the temple portion 104, in accordance with an example embodiment of the present disclosure. FIG. 3B illustrates a schematic top view of the eyewear 100 showing an unfolded state 302 of the temple portion 104, in accordance with an example embodiment of the present disclosure.

In some embodiments, the temple portion 104 of the eyewear 100 may be configured to remain in the folded state 300, in an instance when the eyewear 100 is not in use. In some embodiments, the hinge portion 106 may be configured to allow movement of the temple portion 104 over the axis. In some embodiments, the hinge portion 106 may comprise the first ribbed surface 116 and the second ribbed surface 118. Further, the first ribbed surface 116 and the second ribbed surface 118 may be configured to provide flexibility to the hinge portion 106. In some embodiments, the hinge portion 106 may be configured to allow movement of the temple portion 104 in a clockwise direction and in an anticlockwise direction, upon application of the sufficient amount of the external force by the user.

In some embodiment, when the eyewear 100 may switch from the folded state 300 to the unfolded state 302, the hinge portion 106 coupled with one part of the temple portion 104 may be configured to allow movement to the one part of the temple portion 104 in the clockwise direction. Sequentially, the hinge portion 106 coupled with another part of the temple portion 104 may be configured to allow movement to the another part of the temple portion 104 in the anticlockwise direction. Further, due to movement of the temple portion 104 in the clockwise and anticlockwise direction, the eyewear 100 switches from the folded state 300 to the unfolded state 302 (as illustrated in FIG. 3B).

In some embodiments, when the eyewear 100 may switch from the unfolded state 302 to the folded state 300, the hinge portion 106 coupled with the one part of the temple portion 104 may be configured to allow movement to the one part of the temple portion 104 in the anticlockwise direction. Sequentially, the hinge portion 106 coupled with the another part of the temple portion 104 may be configured to allow movement to the another part of the temple portion 104 in clockwise direction. Further, due to movement of the temple portion 104 in the anticlockwise direction and the clockwise direction, the eyewear 100 switches from the unfolded state 302 to the folded state 300 (as illustrated in FIG. 3A).

In some embodiments, each hinge portion 106 is configured to maintain the position of a respective part of the temple portion 104 in the unfolded state 302 and/or the folded state 300 when a sufficient amount of force is not applied to the respective part of the temple portion 104. For example, when the temple portion 104 is in the folded state 300, the temple portion 104 may remain in the folded state 300 until a sufficient amount of force is exerted on the temple portion 104 to move the temple portion 104 from the folded state 300 to the unfolded state 302. Similarly, when the temple portion 104 is in the unfolded state 302, the temple portion 104 may remain in the unfolded state 302 until a sufficient amount of force is exerted on the temple portion 104 to move the temple portion 104 from the unfolded state 302 to the folded state 300.

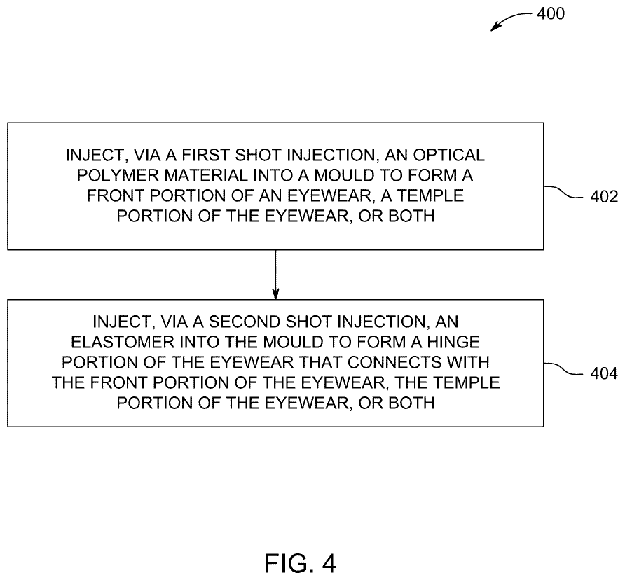

FIG. 4 illustrates a flowchart showing a method 400 for forming the eyewear 100, in accordance with an example embodiment of the present disclosure. FIG. 4 is described in conjunction with FIGS. 1A-3B.

At operation 402, the optical polymer material may be injected into the mould to form the front portion 102 of the eyewear 100, the temple portion 104 of the eyewear 100, or both by the first shot injection. Further, the two shot moulding process may comprise the first shot injection. Further, the optical polymer material may be injected into the mould during the two shot moulding process at the predefined temperature to from the eyewear 100. Further the predefined temperature may range between 250-270 degree Celsius. Further, upon injecting the optical polymer material through the first shot injection, the optical polymer material may be moulded during the two shot moulding process at the predefined temperature to cast the front portion 102 of the eyewear 100, the temple portion 104 of the eyewear 100, or both. Further, the predefined mold temperature may range between 50-70 degree Celsius.

At operation 404, the elastomer may be injected into the mould to form the hinge portion 106 of the eyewear 100 by the second shot injection. Further, the hinge portion 106 of the eyewear 100 may be configured to connect with the front portion 102 of the eyewear 100, the temple portion 104 of the eyewear 100, or both. Further, the two shot moulding process may comprise the second shot injection. Further, the elastomer may be injected into the mould during the two shot moulding process at the predefined temperature to from the eyewear 100. Further the thermoplastic elastomer predefined temperature may range between 220-260 degree Celsius. Further, upon injecting the thermoplastic elastomer through the second shot injection, the thermoplastic elastomer may be moulded during the two shot moulding process at the predefined temperature to cast the hinge portion 106 of the eyewear 100. Further, the mold predefined temperature may range between 20-50 degree Celsius. Further the thermoset elastomer predefined temperature may range between 10-40 degree Celsius. Further, upon injecting the thermoset elastomer through the second shot injection, the thermoset elastomer may be moulded during the two shot moulding process at the predefined temperature to cast the hinge portion 106 of the eyewear 100. Further, the mold predefined temperature may range between 150-300 degree Celsius.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An eyewear comprising:
a front portion;
a temple portion; and
a hinge portion provided between and connecting with the front portion and the temple portion,
wherein the front portion and the temple portion comprise an optical polymer material and the hinge portion comprises an elastomer.

2. The eyewear of claim 1, wherein the eyewear corresponds to a frameless single lens structure, wherein the frameless single lens structure is coated with an anti-fog material.

3. The eyewear of claim 1, wherein the optical polymer material is formulated by adding pigments, colours, or additives to provide optical radiation protection.

4. The eyewear of claim 1, wherein the optical polymer material comprises at least one of a polycarbonate material, polystyrene material, or polymethyl methacrylate material.

5. The eyewear of claim 1, wherein the eyewear is formed by a two shot moulding process comprising a first shot injection and a second shot injection, wherein the optical polymer material is injected during the two shot moulding process at a predefined temperature, wherein the predefined temperature ranges between 250-270 degree Celsius.

6. The eyewear of claim 5, wherein the eyewear is formed by the two shot moulding process comprising the first shot injection and the second shot injection, wherein the optical polymer material is moulded during the two shot moulding process at a mold predefined temperature, wherein the mold predefined temperature ranges between 50-70 degree Celsius.

7. The eyewear of claim 1, wherein the elastomer comprises at least one of a thermoplastic elastomer (TPE), thermoplastic vulcanizate (TPV), thermoset elastomer, thermoplastic polyurethane (TPU) or thermoset liquid silicone rubber (LSR).

8. The eyewear of claim 7, wherein the eyewear is formed by a two shot moulding process comprising a first shot injection and a second shot injection, wherein the thermoplastic elastomer is injected during the two shot moulding process at a predefined temperature, wherein the predefined temperature ranges between 220-260 degree Celsius, and wherein the thermoplastic elastomer is moulded during the two shot moulding process at a mold predefined temperature, wherein the mold predefined temperature ranges between 20-50 degree Celsius.

9. The eyewear of claim 7, wherein the eyewear is formed by a two shot moulding process comprising a first shot injection and a second shot injection, wherein the thermoset elastomer is injected during the two shot moulding process at a predefined temperature, wherein the predefined temperature ranges between 10-40 degree Celsius, and wherein the thermoset elastomer is moulded during the two shot moulding process at a mold predefined temperature, wherein the mold predefined temperature ranges between 150-300 degree Celsius.

10. The eyewear of claim 1, wherein the front portion corresponds to a lens portion that is positioned in front of an eye of a user and the temple portion is configured to fold and unfold due to a flexibility of the hinge portion, and wherein the hinge portion comprises a first ribbed surface and a second ribbed surface, the second ribbed surface being opposite to the first ribbed surface.

11. A method for forming an eyewear, the method comprising:
injecting, via a first shot injection, an optical polymer material into a mould to form a front portion of the eyewear, a temple portion of the eyewear, or both; and
injecting, via a second shot injection, an elastomer into the mould to form a hinge portion of the eyewear that connects with the front portion of the eyewear, the temple portion of the eyewear, or both.

12. The method of claim 11, wherein the eyewear corresponds to a frameless single lens structure, wherein the frameless single lens structure is coated with an anti-fog material.

13. The method of claim 11 further comprising formulating the optical polymer material by adding pigments, colours, or additives to provide optical radiation protection.

14. The method of claim 11, wherein the optical polymer material comprises at least one of a polycarbonate material, polystyrene material, or polymethyl methacrylate material.

15. The method of claim 11, wherein the eyewear is formed by a two shot moulding process comprising a first shot injection and a second shot injection, wherein the optical polymer material is injected during the two shot moulding process at a predefined temperature, wherein the predefined temperature ranges between 250-270 degree Celsius.

16. The method of claim 15, wherein the eyewear is formed by a two shot moulding process comprising a first shot injection and a second shot injection, wherein the optical polymer material is moulded during the two shot moulding process at a mold predefined temperature, wherein the mold predefined temperature ranges between 50-70 degree Celsius.

17. The method of claim 11, wherein the elastomer comprises at least one of a thermoplastic elastomer (TPE), thermoplastic vulcanizate (TPV), thermoset elastomer, thermoplastic polyurethane (TPU) or thermoset liquid silicone rubber (LSR).

18. The method of claim 17, wherein the eyewear is formed by a two shot moulding process comprising a first shot injection and a second shot injection, wherein the thermoplastic elastomer is injected during the two shot moulding process at a predefined temperature, wherein the predefined temperature ranges between 220-260 degree Celsius, and wherein the thermoplastic elastomer is moulded during the two shot moulding process at a mold predefined temperature, wherein the mold predefined temperature ranges between 20-50 degree Celsius.

19. The method of claim 17, wherein the eyewear is formed by a two shot moulding process comprising a first shot injection and a second shot injection, wherein the thermoset elastomer is injected during the two shot moulding process at a predefined temperature, wherein the predefined temperature ranges between 10-40 degree Celsius, and wherein the thermoset elastomer is moulded during the two shot moulding process at a mold predefined temperature, wherein the mold predefined temperature ranges between 150-300 degree Celsius.

20. The method of claim 11, wherein the front portion corresponds to a lens portion that is positioned in front of an eye of a user and the temple portion is configured to fold and unfold due to a flexibility of the hinge portion, and wherein the hinge portion comprises a first ribbed surface and a second ribbed surface, the second ribbed surface being opposite to the first ribbed surface.
